(19) United States
(12) Patent Application Publication
(10) Pub. No.: US 2006/0204070 A1
(43) Pub. Date: Sep. 14, 2006

(54) Three-dimensional x-ray imaging with Fourier reconstruction

(76) Inventor: Waldo S. Hinshaw, Burlingame, CA (US)

Correspondence Address: WALDO HINSHAW, 164 CHAPIN LANE, BURLINGAME, CA, 94010, US

(21) Appl. No.: 10/906,769

(22) Filed: Mar. 5, 2005

(51) Int. Cl. G06K 9/00; G06T 15/00

(52) U.S. Cl. 382/132; 382/128; 382/154; 345/419

(57) ABSTRACT

This invention is a method of generating images of the interior of an object through the use of x-rays or other radiation that is attenuated upon passing through the object. This technology is known as computed tomography, or CT. In the prior art, the x-ray source is moved around or over the object while the r-ray attenuation is observed at multiple locations of the source and while the object stays within the beam of x-rays. The current invention is an efficient method of generating images of the interior of an object by passing the object in a straight line between an x-ray source and a two-dimensional detector array. As the object passes from one side of the cone-beam of x-rays to the other, each detector element records a one-dimensional parallel-ray projection of a slice of the object. The projections so obtained are Fourier transformed and added into Fourier-space according to the projection-slice theorem. Images of the interior of the object are then obtained by taking the inverse Fourier transform of the data in Fourier-space. This method of imaging has the deficiency that results from incompletely populated Fourier-space. The spatial resolution in one direction can depend upon the spatial resolution in another direction. This is the same deficiency suffered by tomosynthesis, an important prior art method of CT. With the current invention, the deficiency can be removed by taking additional projections with the object in a different orientation. Except for the motion of the object, this invention is a CT imaging system with no moving parts.

### BACKGROUND OF INVENTION

This invention is a method of generating images of the interior of an object through the use of x-rays or other radiation that is attenuated upon passing through the object. This technology, known as computed tomography or CT, is widely used for medical diagnosis and for other applications. Most CT imaging systems rotate an x-ray source around the object being imaged while observing the r-ray attenuation at multiple locations of the source. Complex computer algorithms are used to reconstruct an image of the distribution of attenuation in the object. Such an approach to CT will be referred to as circular CT.

Perhaps the earliest method of forming an image of an interior slice of an object was x-ray tomography in which the x-ray source and a photographic plate were placed on either side of an object. Both the source and plate were moved in opposite directions during the exposure with the motion parallel to the plate. This was done in a manner that kept a single plane through the object at the fulcrum of the motion. The exposed plate obtained a relatively clear image of that plane while planes above and below were blurred as a result of the motion. Tomosynthesis, a specific method of CT, is essentially the same as the early tomography except that the photographic plate is replaced by a detector array that can supply raw images, or projections, to a computer. A projection of an object is the attenuation as a function of position as observed by a set of x-rays passing through the object. At multiple locations of the source and detector array, projections of the object are collected. Then a computer algorithm reconstructs a set of images of slices that usually are parallel to the detector array. The simplest such reconstruction algorithm is known as shift and add. Roughly speaking, each of the projections is shifted with respect to the others and then added into a final image. By choosing the correct shifts, a single plane through the object has all of the separate projections in registration as in early tomography. The advantage of tomosynthesis over early tomography is that each projection is stored separately so that, once the projections are obtained, different shifts can be applied in order to bring other planes into focus.

Tomosynthesis works by moving both the x-ray source and detector array on either side of a stationary object. In some tomosynthesis systems, the object and detector array are stationary while the source moves. The source moves in a straight line, circle, or other trajectory usually a fixed distance from the detector array. In both tomosynthesis and circular CT systems, the object, or the part of the object being imaged, remains substantially stationary and substantially within the fan or cone of x-rays during the collection of projections. The cone of x-rays, or cone-beam, is the set of x-rays that go between the source and a two-dimensional detector array. A fan-beam is the set of x-rays that go between the source and a one-dimensional detector array.

In both circular CT and tomosynthesis systems, complex and expensive electromechanical assemblies are required to perform accurate and repeatable movement of the source and, in many cases, the detector array. In tomosynthesis systems, since the cone-beam changes shape as the projections are being recorded, and since different parts of the object receive different ranges of x-ray angles, complex reconstruction algorithms are required.

### SUMMARY OF INVENTION

An efficient method is described for obtaining two or three-dimensional x-ray images by passing the object to be imaged between an x-ray source and a detector array. As the object passes from one side of the fan-beam or cone-beam of x-rays to the other, each detector element records a one-dimensional parallel-ray projection of a slice of the object. According to the well-known projection-slice theorem, the Fourier transform of each such projection can be placed into Fourier-space as a line of numbers through the origin and at right angles to the parallel rays. After the object has passed between the source and detector array, the projections obtained by the detector elements are Fourier transformed and placed into Fourier-space. Then the image or images of the object are obtained by taking the inverse Fourier transform of the data in Fourier-space.

With this invention, herein called tomolinear imaging, the cone or fan of x-rays does not change shape during the imaging procedure as it does with tomosynthesis. As a result, in tomolinear imaging, all of the rays recorded by a given detector element are parallel to each other. Since the object moves in a straight line and starts and ends up substantially outside of the cone, a given detector element provides a one-dimensional parallel-ray projection of a two-dimensional slice of the object. A parallel-ray projection is one in which the rays used to make the projection are parallel. The said two-dimensional slice can be any thickness and can include the entire object.

The term Fourier transform includes the usual Fourier transform and similar transforms. The term Fourier-space, or simply F-space, is the space that contains data such that a Fourier transformation of the data results in an image of the object. F-space is also referred to as an intermediate array. The Fourier transform of a one or two-dimensional projection as it is placed into F-space is called a Fourier-component, or simply F-component. Although F-components are the result of a Fourier transform, each F-component is only a component of the final F-space data. A two-dimensional image of an object is a representation of the distribution of the attenuating material in a slice of the object. The slice can be relatively thin or can include the entire object. The slice can go through the entire object or through a portion of the object. A three-dimensional image consists of multiple two-dimensional images, each of a different slice of the object. A detector array is any means of collecting information about x-ray intensity at multiple locations. The term object includes any localized or extended material that can absorb, attenuate, or deflect x-rays and which can fit between the source and detector array. The part of the object being observed is assumed to be substantially fixed in shape during the observation. The term x-ray is used for simplicity but is intended to include any radiation that can travel through the object in substantially straight lines.

The aforementioned projection-slice theorem, which also is known as the central-slice theorem or the Fourier-slice theorem, is invoked by most reconstruction from projection algorithms that are based on Fourier transformation. According to the two-dimensional projection-slice theorem, the Fourier transform of a one-dimensional parallel-ray projection of a two-dimensional slice of an object is the same as a line of data in the two-dimensional Fourier transform of said slice of the object. The said line of data goes through the origin of the two-dimensional F-space and is perpendicular to the direction of the rays. According to the three-dimensional projection-slice theorem, the Fourier transform of a two-dimensional parallel-ray projection of an object is the same as a plane of data in the three-dimensional Fourier transform of the object. The said plane of data goes through the origin of the three-dimensional F-space and is perpendicular to the direction of the rays.

Since the geometry of tomolinear imaging provides parallel-ray projections, the projection-slice theorem can be used. Note that the theorem cannot be applied to projections obtained with non-parallel rays as produced by tomosynthesis and other CT methods.

Tomolinear imaging is different from other CT methods in that the source and detector are fixed with respect to each other and move in a straight line relative to the object being imaged. The current invention has several advantages over other CT methods. Since there are no moving parts except for the motion of the object relative to the source and detector, the complex electromechanical assembly required for other CT systems is not needed. This means that an imaging system using tomolinear imaging can be much cheaper and more reliable. The fact that the cone-beam or fan-beam is stationary and does not change shape means that the reconstruction algorithm is simpler and faster. Also the fact that the cone-beam does not change shape means that fixed collimators can be used with the detector array to reduce scatter. Another improvement of the invention over other CT methods is that it allows objects to pass through the system without stopping. This facilitates applications such as industrial product monitoring and baggage scanning. In medical applications, the method provides economical and efficient three-dimensional whole-body scanning. It also can be used to scan parts of the body, such as the breast. Not counting the mechanism for moving the object relative to the source and detector, the current invention is a CT scanner with no moving parts.

### BRIEF DESCRIPTION OF DRAWINGS

FIG. 1 shows the geometry of a preferred embodiment of the invention with the coordinate system fixed in the object, 6, and the source, 1, on the x-axis, and the detector array, 2, in the y=D plane above the source, and a representative ray, 4, which goes from the source, 1, to the detector element, 3.

FIG. 2a is a simple representation of a two-dimensional fan of x-rays showing the source, 7, and detector array, 8, and a representative ray, 9, hitting a detector element, 10.

FIG. 2b shows the lines of data, or F-components, in F-space that correspond to the rays shown in FIG. 2a.

FIG. 3 shows the location of data in F-space with the limits of original data at 14 and 15 and the selected rectangular area of data, 16.

FIG. 4 shows the geometry of a single slice with the source, 17, and detector array, 18, and a ray, 21, going through the point-object, 20.

### DETAILED DESCRIPTION

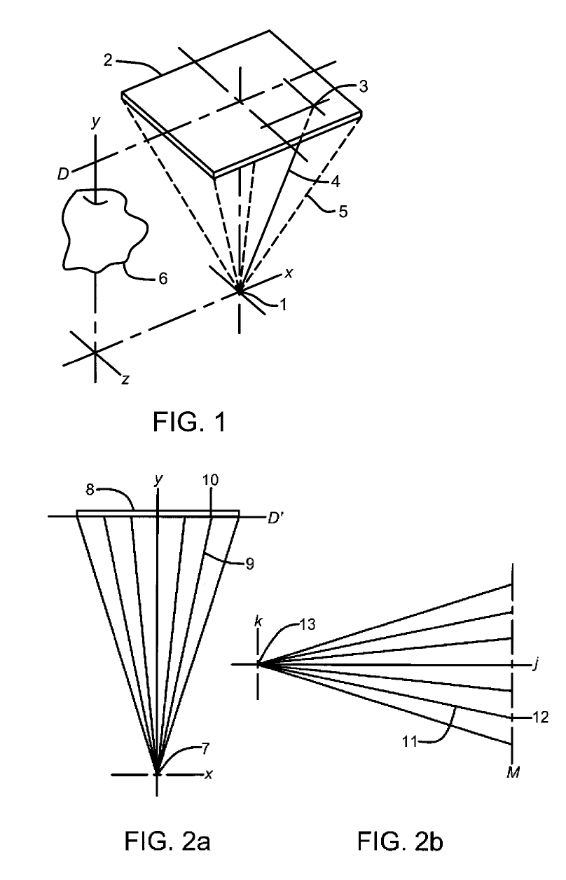

The following description of a preferred embodiment is not intended to restrict the scope of the invention. With reference to FIG. 1, the following embodiment assumes a coordinate system fixed in the object, 6, with the source, 1, and detector array, 2, moving from one side of the object to the other. The source and detector array and the framework supporting it will be referred to as the assembly. A representative ray, 4, is shown going from the source, 1, to the detector element, 3. For this embodiment, the detector elements are assumed to form a flat rectangular array, 2, centered a distance D above the source, 1. The rays fill the cone, called the cone-beam, indicated in FIG. 1 by dashed lines such as 5. In order to make the following equations a little simpler, the source is kept on the x-axis and the detector array is in the positive y-direction.

Either the assembly or the object or both could move but for the mathematical description, it is easier to assume that the object is stationary and that only the assembly moves. Since the assembly moves in a straight line in the x-direction, the three-dimensional problem can be treated as a set of two-dimensional reconstructions. All of the detector elements with the same value of z detect rays that go through the same two-dimensional slice of the object. Each of these tilted two-dimensional slices can be reconstructed separately and then combined in image-space to obtain the three-dimensional distribution. In the following, such a tilted two-dimensional slice will be discussed. Although it is possible to design an imaging system according to this description that has a one-dimensional detector array and which acquires the image of a single slice through the object, this preferred embodiment assumes that a two-dimensional detector array is used and multiple slices through the object are imaged.

The first step is to obtain the projections. Referring to FIG. 1, move the assembly over the object in the x-direction and at regular distance intervals, δs, record the output of each detector element. The logarithm of the intensity is the attenuation, g_{m,n}, with subscript m indicating the source location in the x-direction and subscript n indicating the detector element location in the x-direction. The source location is x=mδs and y′=0 with m an integer ranging from −M to M. The prime on the vindicates that it is a dimension in the tilted slice. The extreme locations of the source, ±L=±Mδs, are chosen so that the cone is outside of the object at the beginning and end of its travel. The detector element locations in the x-direction with respect to the center of the detector array, which is the same as the source location, are nδd with n an integer ranging from −N to N. The detector element separation in the x-direction is δd.

FIG. 2a shows a simple two-dimensional fan-beam of x-rays created by the source, 7, and a one-dimensional array of detector elements, 8. The ray indicated in the figure as ray, 9, hits the n-th detector element, 10, which has the x-location nδd with respect to the center of the detector array. As the assembly moves over the object, the output of the n-th detector element provides the n-th parallel-ray projection of the slice. If g_{m,n} is taken to be a function of m, it is a parallel-ray projection with 2M numbers. If, on the other hand, g_{m,n} is taken to be a function of n, it is a divergent-ray, or fan-beam, projection with 2M numbers. The rays are closer together in the parts of the object that are closer to the source. However, for a given set of parallel rays, the ray separation is the same throughout the object. Since the fan-beam shown in FIG. 2a is in a tilted slice, the distance from the source to the detector array is farther than D, the distance in the non-tilted central slice. This is reflected by adding a prime making it D′.

As an object passes through the cone, each detector element records a projection of about the same length. However, for a given detector element, the actual projection of the object starts and stops at different source locations. The detector element on the leading edge of the cone starts its projection before the one on the trailing edge. Thus there may be advantages to starting to record the information from each detector element as the leading edge of the object gets to it and stop when the trailing edge leaves it. If this is done, each projection is offset in space from the others. It is possible to take the Fourier transform of the offset data and then, before loading the transform into F-space, apply a phase-shift to correct for the offset. In order to facilitate this modification, an object carrier can be used that constrains the object to a region in space that is coordinated with the starting and stopping of the recording of each detector element. Another possibility is to have the system start recording intensities when it senses an object entering the cone-beam and stop recording when it senses the object leaving. One advantage would be the reduction of noise and another would be the reduction of the size of the projection data sets.

The next step is to compute the Fourier transforms of the parallel-ray projections. The j-th number in the Fourier transform of the n-th projection is f_{j,n} where

$${F}_{j , n} = \frac{1}{2 M} {\sum }_{m = - M}^{M - 1} {g}_{m , n} exp ( \frac{- ⅈπ mj}{M} ) 0 \leq j < M \qquad ( 1 )$$

In this equation, g_{m,n} is real while the Fourier series coefficients, F_{j,n}, are complex. The ½M factor, although not necessary, is included so that the zeroth coefficient will be the average of the projection. In this equation, the range of j includes non-negative values. A slightly different equation can be used that includes both positive and negative values of the index j.

The next step is to place each of these one-dimensional Fourier transforms into two-dimensional F-space. It is convenient to use a Cartesian coordinate system with coordinates j and k for F-space. Since the source is fixed with respect to the detector array, all rays detected by a given detector element are parallel. According to the projection-slice theorem, the Fourier transforms of the projections go into F-space as lines of data through the origin and at right angles to the corresponding ray direction. Referring to FIG. 2b, line 11 is the F-component corresponding to ray 9 in FIG. 2a. Since each detector element sees rays with a different slope, each F-component goes into F-space at a different location as shown in FIG. 2b. The n-th F-component is obtained from the n-th detector element. As can be seen from FIG. 2a, a ray hitting the n-th detector element at nδd has the slope D′/nδd. The slope of the F-component corresponding to the ray with slope D′/nδd is −nδd/D′. Thus the location of the n-th F-component line in F-space is given by k=−jnδd/D′. Since this is not an integer, the F-components have to be modified in order to force the numbers into the cells of F-space. For convenience, the numbers in the F-space coordinate system are said to reside in cells. The process of loading the numbers from the radial F-component lines into the F-space cells is called gridding. This well-known process is used when Fourier reconstruction is done in other CT reconstruction algorithms.

The gridding process for this embodiment is necessary only in the k direction. By assigning M points in the j-direction, each point in the F-component lines falls into a column of Cartesian F-space. This results from the fact that the distance between adjacent rays in each parallel-ray projection depends upon the slope of the rays. For the parallel-ray projection provided by the detector element at n=0, the distance between adjacent rays is simply δs. A little geometry shows that for the n-th detector element, the ray separation, δr, is given by

$$δ r = \frac{δ {sD}^{′}}{\sqrt{{D}^{′2} + {n}^{2} δ {d}^{2}}}$$

From Eq. (1), the spacing of the points in the Fourier transform of the projection is the inverse of the spacing of the points, δr, in the projection. With these facts and a little algebra, it is easy to show that the spacing of the F-component points in the j-direction is simply the inverse of the source location spacing regardless of the slope of the F-component. This is reasonable since the detector elements that are far away from the center of the detector array see parallel rays that have a large tilt and are relatively close together. The points on the corresponding F-component lines are thus relatively far apart. Thus, as stated above, by assigning M points in the j-direction, each of the points in the F-component lines falls into a column of Cartesian F-space.

A simple gridding process that is adequate for purposes of illustration is to simply add each number from the F-component lines into its nearest cell of F-space. In other words, simply set k equal to the integer closest to jnδd/D′ and add the number from the F-component line with indices j and k into the Cartesian F-space cell with indices j and k. After all of the numbers have been added into Cartesian F-space, divide the total in each cell by the number of numbers that were added into the cell. If a cell receives no number, fill it with the linear combination of the numbers on either side. Although this simple process of averaging and interpolation might not give optimum image quality, it obviates the need for the data-density correction that is often required with other gridding procedures. The data-density correction is needed in some algorithms to correct for the fact that the F-component lines or planes all go through the origin of F-space which causes the data points to be closer together near than the origin than far away from it. One way to check the gridding process and the data-density correction is to use a point-object, either a mathematical point or an actual small object, and see if the resulting F-space sinusoid has uniform intensity in F-space.

In order to obtain high spatial resolution in the x-direction, it is necessary to use many separate source locations. This is different from tomosynthesis where the spatial resolution in the direction of motion is determined primarily by the resolution of the detector array. With tomosynthesis, it is possible to use a fine-grained detector array and sparse object locations so that relatively few separate exposures are required. However, with tomolinear imaging, the resolution in the x-direction is determined primarily by the source location spacing. A large δs results in wide empty spaces between the rays in each parallel-ray projection. With tomolinear imaging, the optimum image quality results from taking a separate projection roughly every time the source moves the distance δd. In this respect, tomolinear imaging is more like circular CT.

Once all of the F-components have been loaded into F-space, F-space contains a different function from the f_{j,n} of Eq. (1). That equation has F as a function of j and n, but F-space has coordinates j and k. Denote the data in F-space by F′_{j,k} with the prime indicating the two-dimensional function in F-space.

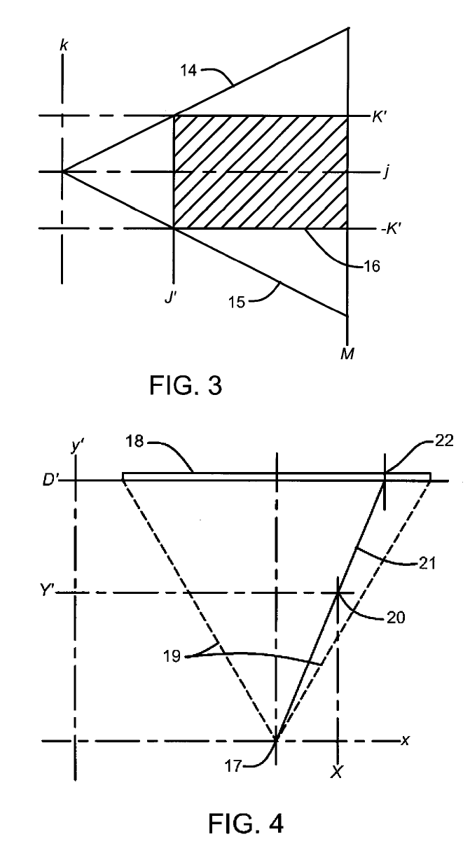

After the assembly has gone over the object and all of the data has been loaded into F-space, empty areas remain in F-space. As shown in FIG. 3, only a triangle has been populated, the area bounded by the lines 14, 15, and M. Since the image is going to be obtained by taking the Fourier transform of this data, the empty areas cause low spatial frequencies in the x direction to have less resolution in the y-direction. This deficiency does not occur in circular CT systems where the source and detector rotate around the object in order to collect projections in all angles. But this deficiency does occur in tomosynthesis, a technique that, nonetheless, has important applications. One possible way to ameliorate the effect of this data deficiency is to further limit the data in F-space so that its edges are vertical and horizontal. This is done by limiting the range of data in both j and k directions. As an example, limit the data in F-space to the shaded area shown in FIG. 3. The limits of the data in the k-direction are −K′ and K′ while the limits of the data in the j-direction are J′ and M. The corners of the rectangle of accepted data need not be exactly on the lines of maximum slope. Depending upon the application, experience, and other considerations, it might be better to put the corners somewhat outside the lines of maximum slope. It is possible to make the data limits interactive so that an operator can adjust them while watching the images.

Removing the data with small values of j removes the low spatial frequencies in the x-direction from the image. In other words, the areas of uniform intensity in the image are removed and the edges enhanced. Removing the data with large values of k removes high spatial frequencies in the y-direction. Limiting the data in F-space to a rectangle causes the spatial resolution in one direction to be independent of the spatial resolution in the other direction.

As with any Fourier signal processing, it usually is necessary to reduce the amplitude of the data in F-space as it nears the edges, whether or not the data has been additionally limited to a rectangle as described above. Such data modification suppresses the ringing artifacts caused by abrupt termination of data in F-space. It also can reduce the noise in the final images. Reduction near the edges in the k-direction defines the shape of the image slice cross-section if the image slice is parallel to the y=0 plane. This can be done so that adjacent images are independent and contiguous. Zeros can be added in order to provide thin, closely-spaced images even though they would not be independent.

Multiply the F-space data by a function that takes the data smoothly to near zero at the edges. A convenient, but probably not optimum, function to use for this is the roughly bell-shaped Gaussian function.

$$h ( a ) = exp [ \frac{- {( a - {a}_{0} )}^{2}}{2 {σ}^{2}} ]$$

In this equation, aₒ is the center and σ is a measure of the width. To take the function down to C factors of 1/e at a distance A away from its center, set o²=A²/2C. To apply this function to the F-space data in the k-direction, set A=K′ and multiply the data by the function hₖ where

$${h}_{k} = exp ( \frac{- {Ck}^{2}}{{K}^{′2}} )$$

When this function is applied to the data in F-space, two-dimensional images parallel to the y=0 plane will have a cross-sectional shape given by the Fourier transform of the above Gaussian, which also is a Gaussian.

$${H}_{p} = exp ( \frac{- {p}^{2} {K}^{′2}}{4 C} )$$

This reaches half-height at (pK′)²=2.79/C giving a half-height width given by (pK′)²=11.1/C. Larger values of C result in less ringing but less spatial resolution in the y′ direction.

Taking the data to near zero as j approaches M is appropriate since, if M is properly chosen, the useful information goes to zero as j approaches M. Also, if the data is restricted to a rectangle, this function also needs to take the data to near zero at J′ as well as at M. This can be done by using the Gaussian function in the j-direction centered between J′ and M.

It may be helpful to increase the number of points in image-space. A convenient way to accomplish this is to add zeros to either side or both sides of the projections before taking the Fourier transforms. Adding zeros dies not increase the spatial resolution, however.

The next step is to transform the data from F-space to image-space by taking the two-dimensional Fourier transform of the F-space data, F′_{j,k}. The F-component corresponding to the n=0 projection, the projection from the vertical ray, puts data into F-space along the j-axis. The spacing of the rays in the x-direction was δs. Thus if we take the inverse transform of Eq. (1), the point separation in the x-direction of the image is also δs. If the F-components for the other rays were placed into the F-space array with the above mentioned slope, and a similar transform taken in the k-direction of F-space, the point separation in the y-direction of the image is also δs. The image, the distribution of attenuation in F-space, f_{p,q}, is thus

$${f}_{p , q} = {\sum }_{j = 0}^{M - 1} {\sum }_{k = - M}^{M - 1} {F}_{j , k}^{′} exp ( \frac{ⅈπ pj}{ M} ) exp ( \frac{ⅈπ qk}{M} )$$

In this equation, p and q are integers such that −M≦p<M and −M≦q<M The image point spacing is δs in both directions and the image size is 2Mδs by 2Mδs. The limits of the summation in the above equation can be changed to correspond to the limited range of data in F-space. The real part of the function f_{p,q} in the above equation is the reconstructed distribution of the object's attenuation in the tilted slice of the object if p is replaced by x/δs and q is replaced by y′/δs. The prime on the y′ indicates that it is the y in the tilted slice, which is different from the yin the original coordinate system. Using L=Mδs and taking the summations only over the rectangle shown in FIG. 3,

$$f ( x , {y}^{′} ) = Re \{ {\sum }_{j = {J}^{′}}^{M - 1} {\sum }_{k = - {K}^{′}}^{{K}^{′} - 1} {F}_{j , k}^{′} exp ( \frac{ⅈπ xj}{L} ) exp ( \frac{ⅈπ {y}^{′} k}{L} ) \} \qquad ( 2 )$$

This equation can be modified to make it easier to apply FFT algorithms by going to the new indices j′=j−J′ and k′=k+K so that

$$f ( x , {y}^{′} ) = Re \{ exp [ \frac{ⅈπ}{L} ( {xJ}^{′} - {y}^{′} {K}^{′} ) ] {\sum }_{{j}^{′} = 0}^{M - {J}^{′} - 1} {\sum }_{{k}^{′} = 0}^{2 {K}^{′} - 1} {F}_{{j}^{′} + {J}^{′} , {k}^{′} - K}^{′} exp [ \frac{ⅈπ }{L} ( {xj}^{′} + {y}^{′} {k}^{′} ) ] \}$$

The next step is to combine the distributions in the separate tilted slices described above in order to obtain the distribution in three dimensions. The separate slices can be put through another gridding or interpolation process in order to create image slices in other orientations. The way the process is described above, the y′ point spacing in the tilted slice is δs. It is straight forward to modify the above process in order to make the y′ point spacing depend upon the tilt of the slice so that the slices will fit together in a way that does not require gridding in the y-direction. However, since each slice is tilted, gridding is still required in the z-direction. Follow the usual practice of imaging an array of accurately located point objects in order to make sure the reconstructed dimensions are correct.

In order to further clarify the ideas of this invention, the following discussion goes through some of the steps of the above embodiment taking as the object a single point, a point-object. Assume the point-object has attenuation g and is located at (X, Y′) in a given tilted slice. The prime on the Y′ indicates that it is a location in the tilted slice. With reference to FIG. 4., the source, 17, together with the detector array, 18, form a fan-beam of x-rays with edges, 19, indicated by dashed lines. One ray, 21, is shown passing through the single point-object, 20. This ray hits the n-th detector element, 22, of the detector array, 18. Note that mδs, the x-location of the source, 17, is the distance from the coordinate system origin while nδd, the x-location of the detector element, 22, is the distance from mδs, the x-location of the source. As can be seen from FIG. 4. using similar triangles, g_{m,n} is zero everywhere except when

$$m = \frac{X}{δ s} - \frac{{Y}^{′} δ d}{{D}^{′} δ s} n \qquad ( 3 )$$

The summation over m in Eq. (1) is non-zero only when m is given by the above equation. Since the source moves such that the fan goes from outside of the object to outside of the object on the other side, every parallel-ray projection has one source location, m, with the point-object in it. Thus Eq. (1) becomes simply

$${F}_{j , n} = \frac{g}{2 M} exp ( \frac{- ⅈπ mj}{M} ) \frac{g}{2 M} exp [ \frac{- ⅈπ j}{M} ( \frac{X}{δ s} - \frac{{Y}^{′} δ d}{{D}^{′} δ s} n ) ] 0 \leq j \leq M \qquad ( 4 )$$

In this equation, m has been replaced by the m of Eq. (3). Remember that for each of the n parallel-ray projections, the Fourier transform of the projection, f_{j,n}, is a function of j. This one-dimensional Fourier transform is a simple sinusoidal function.

The next step is to place each of these one-dimensional Fourier transforms into Cartesian F-space. As discussed above, the slope of the n-th F-component line is −nδd/D′. Thus for a given value of n, the value of k, the F-space index corresponding to the y′-direction, is k=−jnδd/D′. Actually, k has to be an integer and this expression is not an integer. The gridding process referred to above is used to convert k to an integer. But, in order to show what is happening, it is easier to ignore the fact that the indices have to be integers and use this non-integer value for k. With this value, Eq. (4) becomes

$${F}_{j , k}^{′} = \frac{g}{2 M} exp ( \frac{- ⅈπ j X}{L} ) exp ( \frac{- ⅈπ {kY}^{′}}{L} ) \qquad ( 5 )$$

This equation makes it clear, in so far as the discreteness of the data can be ignored, that the reconstruction of the point-object is accurate. Actually, it would be accurate if the data in F-space were complete. In other words, if we could take the Fourier transform of the above equation over all of F-space, we would have an exact representation of the point-object.

The image of the point-object is obtained by combining Eq. (2) with Eq. (5) giving

$$f ( x , {y}^{′} ) = \frac{g}{2 M} Re \{ {\sum }_{j = {J}^{′}}^{M - 1} exp [ \frac{ⅈ πj}{L} ( x - X ) ] {\sum }_{k = {K}^{′}}^{{K}^{′} - 1} exp [ \frac{ⅈ π k}{M} ( {y}^{′} - {Y}^{′} ) ] \}$$

Roughly speaking, the first summation is non-zero only where x=X and the second summation is non-zero only where y′=Y′. The above equation contains a distortion, or smearing, since the summations are not over the full range of the index values. Also this equation does not include the artifacts that result from the fact that the indices have to be integers. But the purpose of this discussion of how the process reconstructs a point-object is for illustration rather than to derive expressions for the artifacts.

The above described embodiment reconstructs the three-dimensional distribution, or image, by first reconstructing separate two-dimensional tilted slices and then combining these slices into a three-dimensional image. The following describes a second embodiment that is a three-dimensional approach. In this embodiment, the projections are loaded as F-components directly into three-dimensional F-space from which the image is obtained. This embodiment has the advantage over the first embodiment of not requiring the process of combining the separate tilted slices.

The second embodiment uses the idea that a multi-dimensional Fourier transform can be accomplished by breaking the input function into components, taking the transform separately of each component, and adding these separate transforms into the final space. Assume again the same geometry shown in FIG. 1. As the assembly moves over the object, each detector element provides a one-dimensional parallel-ray projection of a slice of the object, the object-slice. Take the one-dimensional Fourier transform of each of these projections. Then create from each such Fourier transform the corresponding F-component plane. This plane will be added into the three-dimensional F-space placed so that it goes through the origin and so that it is orthogonal to the direction of the corresponding parallel rays from which it was derived. Spread the data from each of the one-dimensional transforms over the plane so that any line in the plane that is parallel to the object-slice is the said Fourier transform. In the plane, any line that is orthogonal to the object-slice has a constant value. All F-component planes are added using a gridding process into three-dimensional F-space. The F-space data is manipulated generally as outlined in the first embodiment. The data-density is corrected. Either the data is further limited or the data is taken to near zero at the edges or some combination of the two. A three-dimensional Fourier transform of the F-space data provides a three-dimensional representation of the distribution of attenuation in the object or, in other words, the three-dimensional image of the object.

The numbers on the F-component planes fall into integer j-planes of the Cartesian three-dimensional F-space just as they fell into integer j-lines of the Cartesian two-dimensional F-space. The same is true for the k-planes. The rays that are tilted with respect to the y=0 plane in the object have F-component planes that are tilted in F-space. But the geometry is such that the spacing of the F-component points in the k-direction fall into integer k-planes. Thus in the three-dimensional embodiment, the gridding process is required only in the l-direction of F-space, the direction that corresponds to the z-direction in object-space.

As mentioned above, the single pass of an object through a fixed cone does not provide enough information to generate an artifact-free image. A single pass putting the data into two-dimensional F-space for each slice leaves each separate F-space with areas of no data. A single pass putting the data into three-dimensional F-space for all projections also leaves regions of F-space devoid of data. Using multiple passes with differing object orientations can reduce the missing-data artifacts and at least partially fill in the regions of missing data. When doing such multiple passes, it is convenient to use the above described three-dimensional approach and to combine the data from the different passes into a common three-dimensional F-space.

After doing a single pass according to the first embodiment, the data in F-space for the central slice fills in a triangle as shown in FIG. 3. If the object is rotated by 90 degrees about an axis orthogonal to that slice and another single pass is performed, the data in F-space from the second pass is a triangle rotated with respect to the first triangle by 90 degrees. If the maximum angle of the rays is 45 degrees, the second triangle of data fills in the missing region of F-space. After these two passes, the data for the slice is complete and the missing-data artifact is fixed. Similarly, if the maximum angle of the rays is 30 degrees, three passes with the object rotated 60 degrees between each pass fills in F-space. Other cone angles and relative object orientations are clearly possible. In this multiple-pass, or multipass, approach to tomolinear imaging, either the object or the assembly or some combination of both can be rotated between passes. Also, multiple assemblies at differing orientations can be used.

For simplicity in the above paragraph, the rotation was about an axis orthogonal to the central slice. In fact, the rotation can be about an axis orthogonal to any slice. This slice will be called the common slice. For each orientation of the object, the common slice is through the same part of the object. For the other slices, the rotation of the object does not keep the slices from one orientation through the same part of the object as those from the other orientations. For this reason, the second embodiment is better suited for the multipass approach. The multipass method adds the projections from each pass into a common three-dimensional F-space. Each projection is added in as described above for the second embodiment. As the assembly is rotated relative to the object, the data going into F-space is rotated to match. The processes described above for the single-pass second embodiment are followed for the multipass method. This includes, for example, gridding and data-density correcting. After all of the data has been added into F-space, the inverse transform creates the image of the object.

With a single pass, the object can extend beyond the cone in the direction at right angles to the central slice without causing the “long-body” artifacts, the artifacts caused when incomplete information is obtained. This is true because, in a single pass, no rays go between the slices. However, with multiple passes as described above, that is no longer true. With multipass, in order to avoid the long-body problem, the object needs to stay within the cone except for the direction of motion. An exception to this is a result of the fact that no rays cross from one side of the common slice to the other. As an example of how this exception can be exploited, if the rays through the common slice go to one edge of the detector array instead of to its center, then the object can extend out of the cone beyond the common slice. The part of the object outside of the cone beyond the common slice would not cause long-body artifacts.

Accordingly, the present invention is not limited to the embodiments described herein, but is defined instead in the following Claims.

What is claimed is:

1. A method of obtaining images of the distribution of an internal property of a selected volume of an object, said method comprising the steps of:
irradiating the selected volume with multiple rays of energy that are produced and detected by an assembly consisting of a localized energy source and a detector array said energy source and detector array being spatially fixed with respect to each other;
moving the selected volume through the assembly between the energy source and detector array or allowing the selected volume to move through the assembly or moving the assembly over the selected volume, the relative motion being in a substantially straight line and the motion being such that the selected volume is substantially outside of the assembly both at the beginning and end of the motion;
recording the location of the selected volume relative to the assembly and for each location recording the intensities of the rays that have passed through the object and have been attenuated by said internal property and have been detected by the detector array;
calculating the attenuation from the recorded intensities and computing the Fourier transforms of said attenuation as a function of the recorded location, said Fourier transforms being called F-components;
placing said F-components as lines of numbers or planes of numbers into an intermediate array; and
obtaining an image by taking a Fourier transform of the numbers in the intermediate array.

2. A method according to claim 1, in which the said detector array is a two-dimensional array.

3. A method according to claim 1, in which the said detector array is a one-dimensional array.

4. A method according to claim 1, in which the said intermediate array is a two-dimensional array and into which the F-components are placed as lines of numbers, said F-components having been derived from the rays going through a slice of the selected volume.

5. A method according to claim 4, in which images of two-dimensional tilted slices are separately obtained, said images then being combined to form a three-dimensional image.

6. A method according to claim 1, in which the said intermediate array is a three-dimensional array and into which the F-components are placed as planes of numbers.

7. A method according to claim 1, in which the numbers in the intermediate array is restricted in one or more directions.

8. A method according to claim 1, in which the numbers in the intermediate array are reduced in amplitude near one or more edges.

9. A method according to claim 1, in which placing F-components into said intermediate array involves the gridding process.

10. A method according to claim 1, in which the detector array is flat and is parallel to the direction of the relative motion of the selected volume.

11. A method according to claim 1, in which the selected volume passes through multiple assemblies or through the same assembly multiple times with the selected volume having a different orientation with respect to the assembly or assemblies during each pass.

12. A method according to claim 11, in which the plane normal to the axis about which the object is reoriented is at the edge of the detector array.

13. A method according to claim 1, in which the initiation and termination of the recording of intensities is coordinated with the location of the selected volume as it passes through the assembly.

14. A method according to claim 1, in which separate intensities are collected for multiple x-ray energies.

15. Apparatus for obtaining images of the distribution of an internal property of a selected volume of an object by recording and processing the intensities of multiple rays that have passed through the selected volume and have been attenuated by the said property, said apparatus comprising:
a means for irradiating the selected volume with multiple rays of energy and detecting the resulting ray intensities, said means being an assembly consisting of a localized energy source and a detector array said energy source and detector array being spatially fixed with respect to each other;
a means for ensuring that the said assembly and selected volume move in a substantially straight line with respect to each other;
a means for recording the relative location of the selected volume with respect to the assembly;
a means for recording the information from the detector array and for taking the Fourier transforms of said information;
a means for placing said Fourier transforms into an intermediate array as lines of numbers or planes of numbers; and
a means for taking the Fourier transform of the numbers in the intermediate array and presenting the resulting images.

16. Apparatus according to claim 15, wherein the said assembly includes either beam defining collimators or scatter reduction collimators.

17. Apparatus according to claim 15, including a means for moving the selected volume with respect to the assembly.

18. Apparatus according to claim 17, wherein the means for moving the selected volume includes a carrier that contains the selected volume.

19. Apparatus according to claim 15, including a means for moving the assembly with respect to the selected volume.

20. Apparatus according to claim 15, wherein the detecting means is a flat two-dimensional array of detector elements that is parallel to the direction of motion of the selected volume relative to the assembly.

21. Apparatus according to claim 15, providing the means for the selected volume to pass through multiple assemblies or the means for the selected volume to pass through the same assembly multiple times, said means giving the selected volume a different orientation with respect to the assembly or assemblies during each pass.
